(19) United States
(12) Patent Application Publication
(10) Pub. No.: US 2004/0059045 A1
(43) Pub. Date: Mar. 25, 2004

(54) Water resistant inkjet photo paper

(75) Inventors: Jonathan P. Kitchin, Austin, TX (US); Manisha Sarkar, Austin, TX (US); Shaohua Li, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/254,370

(22) Filed: Sep. 25, 2002

(51) Int. Cl. C08K 3/00

(52) U.S. Cl. 524/507

(57) ABSTRACT

An inkjet printable article is provided. The article includes a substrate with an image receptor layer disposed thereon. The receptor layer comprises (a) a water-soluble alkyl cellulose polymer, (b) a water dispersible cationic urethane polymer, and (c) a material selected from the group consisting of alkoxysilanes and polydimethylaminoethyl methacrylate salts.

### FIELD OF THE INVENTION

The present invention relates generally to inkjet printing, and more particularly to inkjet receptive coatings useful for inkjet printing applications.

### BACKGROUND OF THE INVENTION

Ink jet printing is well established as a convenient and high quality method for the rendition of digitally stored text and photographs into hard copy output, on paper or on other specialty substrates such as overhead transparency film or resin coated paper. In order to print satisfactorily on substrates such as plastics that are impervious to inkjet printer inks, an ink receptive layer is commonly coated onto the substrate. Two distinct types of ink receptive layer may be used for this purpose. Porous receptive layers may be used that absorb the ink primarily by capillary action. Alternatively, polymer coatings (typically non-porous) may be used that swell to absorb the ink. Many aspects of the present disclosure relate primarily to improved ink receptive coatings of the swellable polymer type.

A variety of hydrophilic polymers have been used in ink receptive layers that are designed to swell and absorb aqueous ink compositions of the type commonly used in inkjet printers. Such hydrophilic polymers include polyvinyl alcohol, alkyl cellulose derivatives, polyvinyl pyrrolidone, polyethyloxazoline, polyethylene oxide, and gelatin derivatives. Of these, alkyl cellulose derivatives have been found to be advantageous in providing a coating that rapidly absorbs a variety of aqueous inks but does not become tacky during storage under humid conditions.

Among alkyl cellulose derivatives, hydroxypropylmethyl cellulose has been found to be particularly useful. Ink receptive coatings that include alkyl cellulose derivatives are described, for example, in U.S. Pat. No. 4,575,465 (Viola), U.S. Pat. No. 4,865,914 (Malhotra), U.S. Pat. No. 4,592,954 (Malhotra), U.S. Pat. No. 5,277,965 (Malhotra), and U.S. Pat. No. 6,214,459 (Beck et al.). Alkyl cellulose derivatives have also been used as non-tacky topcoats for ink receptors consisting of two or more layers, as described in U.S. Pat. No. 5,206,071 (Atherton et al.) and U.S. Pat. No. 5,567,507 (Paff et al.).

It is very desirable that an image produced by an ink jet printer should be reasonably resistant to water, at least to the extent that conventional photographs can tolerate light splashes of water without damage. Since the colorants commonly used in inkjet inks include highly water-soluble anionic dyes, this is a particularly challenging objective.

In order to achieve a water-resistant image, it is necessary that the image dyes become immobilized or “fixed” within the ink receptive layer and for the ink receptive layer itself to be insoluble in water. Immobilization and/or insolubilization of the image dyes within the ink receptive layer are often achieved by incorporation of a cationic polymer in the layer. Materials of this type, sometimes described as “mordants” or “dye fixatives”, are often presumed in the art to limit the diffusion of anionic dyes within the image layer through electrostatic attraction between the anionic portion of the dye and the cationic portion of the mordant.

A wide variety of polycationic polymers have been proposed for use as mordants for ink receptive coatings. Quaternary amine salt polymers, either aromatic or aliphatic, are often used for this purpose and are described, for example, in U.S. Pat. No. 4,575,465 (Viola), U.S. Pat. No. 4,554,181 (Cousin et al.), U.S. Pat. No. 4,578,285 (Viola), U.S. Pat. No. 4,547,405 (Bedell et al.), U.S. Pat. No. 5,206,071 (Atherton et al.), U.S. Pat. No. 5,342,688 (Kitchin et al.), and U.S. Pat. No. 6,194,077 (Yuan et al.). Salts of non-quaternized polymeric amines, such as polyvinylpyrridine and polyethylenimine, have also been used as mordants, as described in U.S. Pat. No. 5,474,843 (Lambert et al.) and in U.S. Pat. No. 5,567,507 (Paff et al.). Nitrogen containing materials, including some cationic polymers, have also been combined with hydroxypropylmethyl cellulose to form ink receptive coatings in U.S. Pat. No. 5,866,268 (Sargeant et al.). Most commonly, the cationic polymers used as mordants are water-soluble, but water-insoluble latexes and dispersions have also been proposed. Examples of the latter are described in U.S. Pat. No. 5,686,602 (Farooq et al.).

Most commonly used inkjet printing inks are aqueous solutions. Indeed, it is for this reason that hydrophilic polymers are particularly useful as the primary swellable binder in ink receptive coatings. Due to their hydrophilic nature, these binder materials tend to be soluble in water to varying degrees. Therefore, in order to achieve a water-resistant image, it is desirable to render the binder water-insoluble.

The binder material may be rendered water-insoluble through chemical crosslinking, typically through condensation reactions involving pendant hydroxy, amine or carboxylic groups. Chemical crosslinking agents that can be used for this purpose include, for example, multifunctional molecules that may be aziridines, oxazolines, epoxides, aldehydes and aldehyde precursors, activated organic halides, activated ethylenic compounds, or polyvalent metal salts or chelates. However, alkyl cellulose derivatives are relatively inert towards many crosslinking agents, except at elevated temperatures. Since exposure to elevated temperatures causes many ink receptive layers to blister, the use of chemical crosslinking agents is impractical in many applications to insolubilize the ink receptive layer.

Alkyl cellulose derivatives may also be insolubilized by mixture with relatively high quantities of certain colloidal metal oxide particles (30% by weight or more). Compositions of this type are described in U.S. Pat. No. 5,686,602 (Farooq et al.). However, the insolubilization achieved in this manner comes at the expense of swelling capacity and rate, leading to less favorable ink absorption properties.

Some water-soluble polymers can also be rendered insoluble by mixture with alkoxysilane derivatives, such as tetraethoxysilane. The mechanism is open to speculation, but is believed to involve chain entanglement of the water-soluble polymer with polysilicic acid and adsorption onto silica gel, both of which may be formed as hydrolysis products of the alkoxysilane. Application of this approach in ink jet printing is exemplified in U.S. Pat. No. 6,194,075 (Sargeant et al.) and in European Patent 583,141. As with insolubilization by colloidal metal oxides, relatively large quantities of the silane are typically required (30% or more), again at the expense of swelling capacity and rate.

Insolubilization of certain inherently water-soluble polymeric binders has also been achieved by mixture of the binder with a second water-soluble polymer that is readily crosslinked. Binary polymer blends of this type, in which only one of the components is self-crosslinked, are known as semi-interpenetrating polymer networks (SIPN's). Inkjet receptive coatings based on SIPN's of alkyl cellulose and a second polymer have been described, for example, in U.S. Pat. No. 6,214,459 (Beck et al.) and in U.S. Pat. No. 5,932,355 (Iqbal et al.). In general, such blends exhibit only limited water-resistance.

Reduction in the rate of dissolution in water of ink receptive coatings containing inherently water soluble polymers has also been achieved by blending the water soluble polymer with a water-insoluble polymer dispersion. Aqueous dispersions of water insoluble polyurethanes have been used for this purpose, for example, in U.S. Pat. No. 4,578,285 (Viola). Ink receptive coatings containing blends of polyurethane dispersion and alkyl cellulose are described, for example, in PCT publications 9939914, 0058106, 0061375, and 0000352 and in U.S. Pat. No. 6,225,381 (Sharma et al.). Cationic polyurethane dispersions are often used for this purpose, since they are compatible with other cationic additives such as mordants which are commonly added to ink receptive coatings. The degree of insolubilization of alkyl cellulose brought about by a dispersed polyurethane component is, however, limited for practically useful ink jet receptive coatings. At low addition rates (less than about 50% by weight) of polyurethane, the dispersed particles do not coalesce to form a continuous phase, resulting in a coating that is still substantially soluble. At high addition rates (greater than about 50% by weight), the polyurethane component may coalesce to form a continuous phase throughout the coating, resulting in near complete insolubilization. However, under these conditions, the swelling rate and capacity of the coating is reduced to unfavorable levels for ink jet recording. Blends of alkyl cellulose and polyurethane dispersion containing high levels of polyurethane have also been described in applications other than ink jet printing, for example, in the formulation of water-insoluble caulks, as described in U.S. Pat. No. 5,134,180 (Loth et al.).

In some binder systems, alkoxysilanes have been used to render the binder water-insoluble. For example, the use of alkoxysilanes for this purpose in certain coating formulations is described in U.S. Pat. No. 6,194,075 (Sargeant et al.) and in EP 583,141. While the use of these materials is indeed found to reduce the water-solubility of the ink receptive coating, the water absorptivity of the coating is found to suffer. In particular, the water absorptivity of the coating is found to decrease with the amount of alkoxysilane added.

There is thus a need in the art for an ink receptive coating, and for inkjet printing media incorporating the coating, that exhibit good water resistance (for both the coating and the ink absorbed into the coating) and good absorbency toward aqueous ink compositions of the type commonly used in inkjet printers. These and other needs are met by the present invention, as hereinafter described.

### SUMMARY OF THE INVENTION

In one aspect, an ink receptive coating composition is disclosed herein which is especially suitable for inkjet printing and which exhibits good water resistance. The coating composition comprises a cellulosic polymer, a cationic polyurethane, and a material selected from the group consisting of alkoxysilanes and amino acrylate polymers. Preferably, the cationic polyurethane, which may have, for example, a polyester or polyether backbone, is in the form of a dispersion, and more preferably is in the form of an aqueous dispersion. The cellulosic polymer is preferably a water-soluble cellulosic polymer such as hydroxypropyl methyl cellulose. The amino acrylate polymer, which may be, for example, a polydimethylaminoethyl methacrylate salt such as a polydimethylaminoethyl methacrylate acetate salt, preferably has a molecular weight of at least about 100,000 g/mol, more preferably at least about 1×10⁶ g/mol, and most preferably at least about 2×10⁶ g/mol. The alkoxysilane is preferably an aminoalkyl silane. The ink receptive coating may also comprise other ingredients, such as mordants or crosslinking agents, and may have a continuous/disperse phase morphology.

In another aspect, a composition is disclosed herein which comprises a water-soluble cellulose polymer, a cationic polyurethane dispersion, and a cationic amino acrylate polymer having a molecular weight of at least about 100,000 g/mol, preferably at least about 1×10⁶ g/mol, and more preferably at least about 2×10⁶ g/mol.

In another aspect, an inkjet printable article is disclosed herein which comprises a substrate having an image receptive layer disposed thereon. The image receptive layer comprises a water-soluble alkyl cellulose polymer, a water dispersible cationic polyurethane polymer, and a material selected from the group consisting of alkoxysilanes and polydimethylaminoethyl methacrylate salts.

In still another aspect, a method for making an inkjet receptive surface is disclosed herein. In accordance with the method, a substrate is provided, and the substrate is coated with a composition comprising (a) a water-soluble alkyl cellulose polymer, (b) a water dispersible cationic urethane, and (c) a material selected from the group consisting of alkoxysilanes and polydimethylaminoethyl methacrylate salts.

In yet another aspect, a method is disclosed herein for creating an inkjet receptive coating. In accordance with the method, a water-borne blend is provided which comprises a water-soluble alkyl cellulose polymer and a cationic urethane polymer. The blend is then treated with a material selected from the group consisting of alkoxysilanes and polydimethylaminoethyl methacrylate salts, thereby producing a treated blend which, after drying, is insoluble in water.

In another aspect, a coating composition suitable for use in inkjet printing substrates is provided. The coating composition comprises a water-soluble alkyl cellulose polymer, a water dispersible cationic urethane polymer, and an insolubilizing agent adapted to render the alkyl cellulose polymer insoluble in water. The insolubilizing agent is selected from the group consisting of alkoxysilanes and polydimethylaminoethyl methacrylate salts. Preferably, the insolubilizing agent is further adapted to render the alkyl cellulose/polyurethane blend insoluble in water.

In yet another aspect, a coating composition suitable for use in inkjet printing substrates is disclosed herein. The coating comprises an alkyl cellulose polymer and a cationic polyurethane polymer having a polyester backbone, and may further comprise a mordant.

These and other aspects are described in greater detail below.

### DETAILED DESCRIPTION OF THE INVENTION

1. Overview

It has now been discovered that an inkjet receptive coating having good water resistance (for both the coating as a whole and the ink absorbed into the coating) and good absorbency toward aqueous ink compositions of the type commonly used in inkjet printers may be made by incorporating an alkoxy silane into a polyurethane (PU) alkyl cellulose (AC) binder. Surprisingly, the PU-AC binder is found to require significantly lower amounts of alkyl silane to render it water-insoluble than is the case for other commonly used binder systems. Consequently, the detrimental effect that alkoxy silanes can have on water absorption can be minimized, and ink receptive coatings can be made based on these materials which have both excellent water resistance and excellent ink absorption.

It has also been discovered that an inkjet receptive coating having good water resistance (for both the coating as a whole and the ink absorbed into the coating) and good absorbency toward aqueous ink compositions of the type commonly used in inkjet printers may be made by incorporating a cationic amino acrylate polymer having a molecular weight of at least about 100,000 g/mol into a PU-AC binder. Surprisingly, the use in PU-AC binders of cationic amino acrylate polymers within this range of molecular weights is found to impart to the ink receptive layer excellent water resistance compared to the results achieved with lower molecular weight cationic amino acrylate polymers in these systems.

Many possibilities exist for the various components and features of the above noted systems. Some of these possibilities are described below, though one skilled in the art will appreciate that these possibilities are not meant to be exhaustive.

Cellulosic Materials

A number of cellulosic materials may be used in the ink receptive coating compositions described herein. These include, for example, cellulose acetate, cellulose acetate phthalate, cellulose acetate propionate, cellulose acetate butyrate, hydroxypropyl methyl cellulose phthalate, alkyl celluloses and hydroxy alkyl celluloses in which the alkyl group has 1 to 3 carbon atoms, cellulose hydroxyalkyl phthalate, hydroxy propyl ethyl cellulose phthalate, hydroxypropyl methyl cellulose phthalate, hydroxypropyl cellulose, cellulose gum, and mixtures of the foregoing. Of these, the use of water-soluble cellulosic materials is preferred, and the use of hydroxypropyl methyl cellulose is especially preferred. One example of a commercially available hydroxypropyl methyl cellulose that is particularly useful in the ink receptive coating compositions described herein is sold under the brand name Methocel® K-35 by the Dow Chemical Company, Midland, Mich.

In some applications of the ink receptive coating compositions disclosed herein, thermoplastic modified cellulosic materials may be employed. Such materials may be advantageous in certain applications in that they have the potential to permit softening of the binder at the temperatures that may be required to bond the ink receptive layer to certain substrates, and may thus facilitate or improve adhesion of the image receptive layer to these substrates.

Urethanes

Various urethanes may be employed in the ink receptive coating compositions described herein. Typically, these urethanes, which are preferably cationic polymers, will be applied in the form of latexes or dispersions of the urethane in a solvent medium of a type which, if dried, form polymeric films on the substrates to which they are applied. The urethane, in combination with the (preferably cellulosic) ink absorptive component of the image receptive layer, may have a continuous/disperse phase morphology, or the mixture may be homogeneous. The morphology obtained will typically depend at least in part on the relative amounts of these two components in the mixture.

The polyurethane dispersions or latexes utilized in the ink receptive compositions described herein are preferably water-borne polyurethane dispersions, that is, dispersions in which the solvent medium is predominantly water. One particular example of such an aqueous dispersion consists of 30% solids polyurethane, 15% N-methylpyrrolidone and 55% water.

Polyurethane polymers may be made for use in the ink receptive coatings described herein that contain various functionalities or moieties in the backbone of the polymer. For example, polyurethanes may be employed that contain polyether or polyester backbones. The use of polyester backbones is particularly advantageous in some applications of the ink receptive coating compositions described herein in that the resulting coatings are often found to exhibit high water resistance. A cationic urethane dispersion with a polyester backbone which is suitable for use in the coating compositions disclosed herein is commercially available under the designation UCX from the Witco Chemical Corporation, Greenwich, Conn. A cationic urethane dispersion with a polyether backbone, which is suitable for use in the coating compositions disclosed herein, is commercially available under the designation W213, also from the Witco Chemical Corporation.

The polyurethane dispersions may be aromatic or aliphatic. However, the use of aliphatic polyurethanes are preferred in the ink receptive coatings described herein in that they yield dried films which are less prone to yellowing.

Alkoxy Silanes

Various alkoxysilanes may be utilized in the ink receptive coatings described herein. Examples of possible alkoxysilanes include, for example, tetraalkoxysilanes such as tetramethoxysilane, tetraethoxysilane, and tetraisopropoxy silane, propyltrimethoxy silane, and aminoalkoxy silanes such as, for example, N-beta aminoethyl gamma-aminopropyl trimethoxy silane.

In some cases, these alkoxysilanes may be used to form water-insoluble polymeric networks which comprise the (possibly acid catalyzed) reaction product of mixtures comprising the alkoxysilane, water, and one or more water-soluble polymers such as those selected from the group consisting of poly(2-ethyl-2-oxazoline), poly(acrylic acid), poly(vinyl pyrrolidone), poly(vinyl alcohol), poly(ethylene glycol), vinylalcohol/vinyl amine copolymer, and gelatin. Some examples of such water-insoluble polymer networks are described in greater detail in U.S. Pat. No. 6,194,075 (Sargeant et al.).

In the ink receptive coatings described herein, the weight % of alkoxysilane in the coating will preferably be within the range of about 1 to about 20%, more preferably within the range of about 1 to about 12%, and most preferably within the range of about 2 to about 7%, based on the total weight of the ink receptive coating composition.

Substrates

The ink receptive coating compositions disclosed herein are especially useful when used in combination with cellulosic substrates such as printer or copier papers of the type commonly employed in inkjet printers. However, these coating compositions may also be used in combination with other substrates, such as transparent plastic films, translucent plastic films, opaque (e.g., white) plastic films, cloth, nonwoven fabrics, cardboard, and combinations thereof. Plastic films that may be used with the ink receptive coating compositions described herein may comprise polyethylene terephthalate, polyethylene, polypropylene, polyvinyl chloride, polycarbonate, cellulose acetate, polysulfone, polystyrene, nylon and polyolefin blends such as polyethylene/polypropylene blends and mixtures of the foregoing. These films may be surface treated to promote adhesion of the ink receptive coating thereto.

Primers

In applications in which the ink receptive coatings described herein are to be applied to film substrates such as polyester transparency films, the substrate may in some cases be treated with a primer to promote adhesion between the ink receptive coating and the substrate. Such primers may include, for example, halogenated phenols that may be dissolved in (typically organic) solvent media. Specific examples of possible halogenated phenols which may be suitable for these purposes include p-chloro-m-cresol, 2,4-dichlorophenol, 2,4,5-trichlorophenol, 2,4,6-trichlorophenol, and 4-chlororesourcinol. Specific examples of organic solvent media that may be suitable include acetone and methanol. The primer may also contain such other materials such as partially hydrolyzed vinyl chloride-vinyl acetate copolymer, polyvinylidine chloride, gelatin, and/or polymers or copolymers based on one or more of these materials.

Surfactants

The coating compositions described herein may contain anionic, cationic, or nonionic surfactants, and these surfactants may be fluorinated or non-fluorinated materials. Fluorinated surfactants may include one or more fluoroaliphatic moieties. These materials may serve, for example, to reduce foaming or bubbling of the composition, promote uniform film formation of the coating on an intended substrate, control dot size, ensure adequate wetting out, and/or enhance ink or dye absorption by, or diffusion into, the ink receptive layer.

Mordants

The ink receptive coating compositions described herein may also include various mordants suitable for insolubilizing commonly used ink jet dyes or pigments. Such mordants include, for example, quaternary salts based on vinylpyridine or vinylbenzyl polymers or copolymers. Such salts are described, for example, in U.S. Pat. No. 4,340,522 (Bronstein-Bonte et al.) and in U.S. Pat. No. 4,575,465 (Viola). These salts may be used in conjunction with hydrophilic polymers such as gelatin, hydroxypropyl cellulose, polyvinyl alcohol, or mixtures of these materials. Other mordants include quaternary ammonium compounds such as poly (diallyldimethylammonium halide), poly (diethylallylamine hydrochloride), poly (dialkyldiallyl ammonium halide), poly (dimethyldiaryl ammonium chloride), poly (diallyldimethylammnonium phosphate), polymeric mordants having at least one guanidine moiety, and mixtures of the foregoing.

The ink receptive coating may also contain metal salt chelating agents, which in some cases may also act as mordants. Thus, for example, the ink receptive coating may include metal salt chelating agents for sodium, calcium, aluminum and magnesium sulfates and halides.

The ink receptive coating may also contain a binder, such as gelatin, which is crosslinked with a mordant such as a quaternary cationic polymer, to yield a water-insoluble product. The binder and cationic polymer may be crosslinked together by a multifunctional cross-linking agent to form a water-insoluble ink receptive coating layer for ink jet recording. In some cases, this crosslinking may result in the formation of an Interpenetrating Polymer Network (IPN). The quaternary cationic polymer in these crosslinked materials may be formed through the reaction of a water-insoluble monomer, such as alkyl methacrylate and alkyl acrylate, and a water-soluble monomer, such as quaternized dialkylaminoalkyl methacrylate and methyl quaternized dialkylaminoalkyl acrylate. The water-soluble monomer may have one or more reactive functional groups, such as hydroxyl, carboxyl or amine groups, which enable it to undergo IPN-forming reactions.

Fillers and Particulates

The ink receptive coatings described herein may also contain various fillers, including microcrystalline fillers, which in some cases may act to improve ink drying times. Examples of suitable fillers include microcrystalline cellulose, silica gel, amorphous silica, colloidal silica, clay, talc, diatomaceous earth, calcium carbonate, calcium sulfate, barium sulfate, aluminum silicate, synthetic zeolite, zinc oxide, lithopone, satin white, cellulose pulp, alumina, polymeric microspheres or beads such as, for example, those derived from poly(methylmethacrylate), and various combinations of the foregoing.

Plasticizers and Anti-Curl Additives

Additives may also be employed in the ink receptive coatings described herein, which aid in the control of curl. Such materials may include, for example, polyhydroxy materials such as xylitol, glycerol, mannitol, pentaerythritol gluconic acid, trimethylol propane, and such plasticizing compounds as low molecular weight polyethylene glycols, polypropylene glycols, or polyethers, such as, for example, PEG 600, Pycal® 94, and Carbowax® 600.

Coating Methods

The ink receptive coating compositions described herein may be applied to a substrate by various methodologies. Such methodologies include, for example, knife coating, wire bar coating, gravure coating, and extrusion coating. Preferably, these coatings are applied to the substrate as a single layer.

Other Materials

The ink receptive coatings described herein may also contain various other additives that may be incorporated to improve processing or other aspects of the coating compositions. Such other additives include thickeners such as xanthan gum, catalysts, adhesion promoters, glycols, defoamers, antistatic materials, and the like.

Water Fastness Test

In this test, strips of a dried, imaged substrate were laid flat on a table and about 20 grams of water were poured onto it. After about 30 seconds, a sheet of paper towel was used to blot the water off of the imaged areas. The amount of image removal or distortion was then recorded. Based on the amount of each ink removed from the imaged areas, the samples were visually graded on a scale of 1 to 5, where 1 indicates 0-5% removal of the inks without ruining the images, and 5 indicates 70% or more removal of the inks resulting in total destruction of the image. The grades in between indicate varying amounts of ink removal.

Gloss Test

Gloss values were measured at an incidence angle of 60° with respect to the test piece using a gloss meter manufactured by Gardner-BYK, Silver Spring, Md., and in accordance with ASTM test D 523. Higher gloss values are typically indicative of greater surface smoothness.

Curl Test

In this test, a sample is placed upon a planar sample holder and is exposed for four hours to an atmosphere in which the temperature is 70° F. and the relative humidity is 50%. The sample is then exposed for another four hours to an atmosphere in which the temperature is 60° F. and the relative humidity is 10%. After this, the amount of curl in mm (measured from the edge of the sample along an axis normal to the surface of the sample holder) for the sample edge that curls the most is taken as the curl reading.

Humid Bleed Test

In this test, imaged samples were put into a pre-conditioned chamber at 95° F. (35° C.) and 80% humidity for 4 days. Under these conditions, many dyes are observed to migrate from their original placement in the image, resulting in blurring or diffusion of the image and color changes. The degree of blurring and color change were graded on a scale of 1 to 5, with 1 indicating the best resistance to humid bleed (little or no diffusion or color change discernible) and 5 indicating the worst resistance to humid bleed (image markedly deteriorated).

Water Rub Test

In this test, several drops of water are applied to the coating to be tested. The coating is then rubbed with a clean cloth, and the amount of coating on the cloth is rated on a scale of 1 to 5, with 1 indicating little or no coating present on the cloth, and 5 indicating that most or all of the coating was removed.

Experimental

The compositions and ink receptive coatings and sheets disclosed herein will now be further described with reference to the following examples. These examples are intended to illustrate various aspects of the compositions and methods disclosed herein. It will thus be appreciated that not every example presented herein is an example in accordance with every inventive aspect of the compositions and methods disclosed herein. Indeed, some examples may not pertain to any inventive aspect, but may merely serve as a comparative example to one or more inventive aspects. Hence, the scope of the present invention should be construed with reference to the appended claims.

In the examples, unless otherwise indicated, all percentages listed for the coating compositions are percentages by weight, based on the total weight of coating composition solids.

In the examples, the following abbreviations have the indicated meanings:

“K-35” refers to Methocel® K-35, a hydroxy propyl methyl cellulose available commercially from the Dow Chemical Company, Midland, Mich.;

“SYN” refers to Syntran HX31-65, a cationic acrylate polymer available commercially from Interpolymer Corporation, Canton, Mass.;

“UCX” refers to a cationic urethane dispersion with a polyester backbone, available commercially from Crompton Corporation, Greenwich, Conn.;

“W213” refers to a cationic urethane dispersion with a polyether backbone available commercially from Crompton Corporation;

“A1120” refers to N-beta aminoethyl gamma-aminopropyltrimethoxy silane, available commercially from Crompton Corporation;

“TEOS” refers to tetraethyl orthosilicate;

“Z-6040” refers to gamma-glycidoxy propyltrimethoxysilane available commercially from Dow Corning Corporation, Midland, Mich.;

“PC 8713” refers to a cationic modified polyacrylamide which is commercially available from Hercules Corporation, Wilmington, Del., and which has an approximate molecular weight of 6 million g/mol;

“XAMA-7” refers to a polyaziridine crosslinking agent available commercially from Ichemco, Milan, Italy;

“CX100” refers to NeoCryl® CX-100, a polyfunctional aziridine liquid crosslinker available commercially from Zeneca Resins, Wilmington, Mass.;

“Poly DMAEMA” refers to poly dimethylaminoethylmethacrylate acetate salt;

“A4M” refers to methyl cellulose having a molecular weight of 1×10⁶;

“N-250L” refers to Natrosol® 250L, a low molecular weight hydroxy ethyl cellulose available commercially from Hercules Chemical Corporation, Wilmington, Del.;

“PVP” refers to polyvinylpyrrolidone having a molecular weight of 1.3 million;

“A-500” refers to Aquazol® 500, a polyethyl oxazoline available commercially from Polymer Chemistry Innovations, Inc., Tucson, Ariz.; and

“U-NFW” refers to Uvitex® NFW, a sulphonated distyryl biphenyl available commercially from Ciba Specialty Chemicals Corporation, Tarrytown, N.Y.

### EXAMPLES E1-E10

These examples illustrate the preparation of several coating compositions in accordance with the teachings herein.

The coating compositions denoted E1-E10 in TABLE 1 were prepared by mixing the components in the indicated weight ratios in water. Coatings were made by using a knife coater to apply the aqueous coating solutions onto a resin coated paper primed with gelatin. The coating was then dried in a convection oven at 265° F. (129° C.) for two minutes. The dried coating weight was within the range of 1.0 to 1.5 g/sf (10.7 to 16.1 g/m²). The dried coated paper was cut into an 8.5 inch×11 inch sheet (21.6 cm×28.0 cm) and was imaged with a test pattern using a Hewlett Packard 970 inkjet printer (available commercially from Hewlett Packard Corporation, Palo Alta, Calif.) set to print on glossy photo paper and at photo quality resolution. The test pattern consisted of 1 inch by 1 inch (2.54 cm by 2.54 cm) blocks and lines of primary colors (cyan, magenta and yellow) as well as blue, green, red and black.

The imaged substrates formed in EXAMPLES E1 to E10 were allowed to dry for 30 minutes, after which they were subjected to the Water Fastness Test. The results are set forth in TABLE 1.

TABLE 1
Percent Composition of Coating Solids and Water Fastness

| | EXAMPLE | | | | | | | | | |
|---|---|---|---|---|---|---|---|---|---|---|
| | E1 | E2 | E3 | E4 | E5 | E6 | E7 | E8 | E9 | E10 |
| Hydroxy- | 53 | 50 | 50 | 50 | 50 | 55 | 75 | 53 | 53 | 52 |
| propyl- | | | | | | | | | | |
| Methyl | | | | | | | | | | |
| Cellulose | | | | | | | | | | |
| (K-35) | | | | | | | | | | |
| Dye | 10 | 15.3 | 15.5 | 15.5 | 15.5 | 15 | 25 | 10 | 10 | 13 |
| Fixative | | | | | | | | | | |
| (Syntran | | | | | | | | | | |
| HX31-65) | | | | | | | | | | |
| Polyurethane | 0 | 30.2 | 30 | 30 | 30 | 0 | 0 | 0 | 0 | 0 |
| Dispersion | | | | | | | | | | |
| (UCX) | | | | | | | | | | |
| Polyurethane | 30 | 0 | 0 | 0 | 0 | 30 | 0 | 30 | 30 | 28 |
| Dispersion | | | | | | | | | | |
| (W213) | | | | | | | | | | |
| Poly | 7 | 0 | 0 | 0 | 0 | 0 | 0 | 0 | 0 | 0 |
| DMAEMA | | | | | | | | | | |
| (MW 2 × | | | | | | | | | | |
| 10⁶) | | | | | | | | | | |
| Poly | 0 | 0 | 0 | 0 | 0 | 0 | 0 | 7 | 0 | 0 |
| DMAEMA | | | | | | | | | | |
| (MW 5000) | | | | | | | | | | |
| Poly | 0 | 0 | 0 | 0 | 0 | 0 | 0 | 0 | 7 | 0 |
| DMAEMA | | | | | | | | | | |
| (MW | | | | | | | | | | |
| 22,000) | | | | | | | | | | |
| Cationic | 0 | 0 | 0 | 0 | 0 | 0 | 0 | 0 | 0 | 7 |
| Acrylamide | | | | | | | | | | |
| Copolymer | | | | | | | | | | |
| (PC 8713) | | | | | | | | | | |
| Alkoxy | 0 | 4.5 | 0 | 2.25 | 2.25 | 0 | 0 | 0 | 0 | 0 |
| Silane | | | | | | | | | | |
| (A1120) | | | | | | | | | | |
| Alkoxy | 0 | 0 | 4.5 | 2.25 | 0 | 0 | 0 | 0 | 0 | 0 |
| Silane | | | | | | | | | | |
| (TEOS) | | | | | | | | | | |
| Alkoxy | 0 | 0 | 0 | 0 | 2.25 | 0 | 0 | 0 | 0 | 0 |
| Silane | | | | | | | | | | |
| (A2120) | | | | | | | | | | |
| Water | 2 | 2 | 3 | 1 | 1 | 5 | 5 | 5 | 5 | 5 |
| Fastness | | | | | | | | | | |

As the results in TABLE 1 indicate, the presence in the coating compositions of aminoacrylates above a certain molecular weight give rise to strikingly better water fastness. In particular, in E1, a water fastness rating of 2 was obtained, while in E8 and E9, which differed significantly from E1 only in the molecular weight of DMAEMA used, water fastness ratings of 5 were obtained in each case.

The results also suggest that the structure of the cationic polymer plays an important role in the water fastness of the composition. Thus, E1 and E10 differ compositionally primarily in that the later employs an acrylamide as the cationic polymer and the former employs an amino acrylate. However, even though the acrylamide and amino acrylate had the same average molecular weight, the amino acrylate gave rise to much better water fastness (rated a 2) than the acrylamide (rated a 5).

The results of TABLE 1 also demonstrate the effect of alkoxy silanes in improving the water fastness of PU-AC coating compositions. In particular, E6 shows that, when a PU-AC binder is used without an alkoxy silane, the resulting binder has very poor water fastness (rated a 5). However, when an alkoxy silane is added as in E2-E5, water fastness improves dramatically. The results are especially impressive when the alkoxy silane is a mixture of silanes. Thus, as shown by EXAMPLES E4 and E5, coating compositions containing mixtures of N-beta aminoethyl gamma-aminopropyltrimethoxy silane with either TEOS or N-beta aminoethyl gamma-aminopropylmethyldimethoxy silane are seen to give better water fastness than coating compositions containing either N-beta aminoethyl gamma-aminopropyltrimethoxy silane or TEOS alone (see EXAMPLES E2 and E3, respectively).

The results of TABLE 1 further suggest that the presence of a dye fixative or mordant in the PU-AC binder composition does not necessarily improve by itself the water fastness of the coating composition. In particular, although E1-E10 all contained the same mordant, they exhibited widely varying water fastness values. This demonstrates the need in the coating composition of a material that renders both the dye and the binder itself water-insoluble in order to obtain good water fastness.

### EXAMPLES E11-E19

These examples illustrate that improvements in water fastness can be achieved with the coating compositions disclosed herein without sacrificing other desirable properties, such as gloss and humid bleed resistance.

Following the general methodology of EXAMPLES E1-E10, the coating compositions denoted E11-E19 in TABLE 2 were prepared by mixing the components in the indicated weight ratios in water. The water fastness ratings of the resulting coatings were then determined in accordance with the Water Fastness Test, and are set forth in TABLE 2. Similarly, the gloss and humid bleed of the resulting coatings were determined in accordance with the Gloss Test and Humid Bleed Test, respectively, and are set forth in TABLE 2.

TABLE 2
Percent Composition of Coating Solids, Water Fastness,
Gloss and Humid Bleed

| | EXAMPLE | | | | | | | | |
|---|---|---|---|---|---|---|---|---|---|
| | E11 | E12 | E13 | E14 | E15 | E16 | E17 | E18 | E19 |
| Hydroxypropyl- | 55 | 51 | 49 | 49 | 62 | 53 | 72 | 52 | 57 |
| Methyl | | | | | | | | | |
| Cellulose | | | | | | | | | |
| Dye | 14 | 13 | 13 | 13 | 16 | 16 | 19 | 16 | 0 |
| Fixative | | | | | | | | | |
| (Syntran | | | | | | | | | |
| HX31-65) | | | | | | | | | |
| Polyurethane | 24 | 30 | 30 | 30 | 21 | 31 | 0 | 30 | 34 |
| Dispersion | | | | | | | | | |
| W213 | | | | | | | | | |
| Poly DMAEMA | 7 | 6 | 6 | 8 | 0 | 0 | 9 | 0 | 8 |
| (MW 2 × 10⁶) | | | | | | | | | |
| CX100 | 0 | 0 | 2 | 0 | 0 | 0 | 0 | 2 | 2 |
| Water Fastness | 2 | 2 | 2 | 2 | 4 | 4 | 4 | 4 | 4 |
| Gloss | 84 | 79 | 76 | 65 | 87 | 85 | 87 | 85 | 55 |
| Humid Bleed | 2 | 2 | 2 | 2 | 1 | 2 | 4 | 2 | 4 |

As the results in TABLE 2 indicate, the coating compositions E15 and E16, which consisted primarily of a cationic polyurethane, water soluble hydroxy propyl methyl cellulose and a cationic mordant, were glossy and exhibited good humid bleed resistance, but had poor water resistance. The addition of a dimethylaminoethylmethacrylate polymer to these coating compositions, as indicated by E11 and E12, significantly improved the water resistance of the coating, without detrimentally affecting gloss or humid bleed resistance.

The results in TABLE 2 also suggest that the use of a crosslinking agent to the coatings of E11 and E12 does not materially affect water resistance, as shown by E13, E18 and E19. On the other hand, the absence of a mordant from the coating compositions was seen to have a detrimental effect on water fastness, gloss and humid bleed, even with the use of a crosslinking agent, as seen by comparing E19 to E11-E14.

### EXAMPLES E20-E33

These examples illustrate that improvements in water fastness can be achieved with the coating compositions disclosed herein without sacrificing other desirable properties, such as gloss and humid bleed resistance.

Following the general methodology of EXAMPLES E1-E10, the coating compositions denoted E20-E33 in TABLE 3 were prepared by mixing the components in the indicated weight ratios in water. The water fastness ratings of the resulting coatings were then determined in accordance with the Water Fastness Test, and are set forth in TABLE 3. Similarly, the gloss and curl of the resulting coatings were determined in accordance with the Gloss Test and Curl Test, respectively, and are set forth in TABLE 3.

TABLE 3
Percent Composition of Coating Solids, Water Fastness, Gloss and Curl

| | | | | | | | | | | | Water |
|---|---|---|---|---|---|---|---|---|---|---|---|
| | K-35 | SYN | UCX | W213 | XAMA-7 | A1120 | TEOS | Z-6040 | Gloss | Curl | Fastness |
| EXAMPLE | (%) | (%) | (%) | (%) | (%) | (%) | (%) | (%) | (%) | (mm) | Test |
| E20 | 32 | 20 | 45 | — | 3 | — | — | — | 86 | 8 | 1 |
| E21 | 32 | 20 | — | 45 | 3 | — | — | — | 79 | 4 | 4 |
| E22 | 49 | 16 | 31 | — | — | 2 | — | 2 | 84 | 10 | 1 |
| E23 | 32 | 20 | 45 | — | — | 4 | — | 4 | 84.5 | 9 | 2 |
| E24 | 50 | 15.5 | 30 | | | 4.5 | | | 87 | 11 | 1 |
| E25 | 50 | 15.5 | 30 | — | — | — | 4.5 | — | 89 | 15 | 3 |
| E26 | 50 | 15.3 | 30 | — | — | 2.5 | 2.5 | — | 78 | 9 | 1 |
| E27 | 47 | 15 | 29 | — | — | 4.5 | — | 4.5 | 82 | 6 | 1 |
| E28 | 50 | 15.3 | 30.2 | | — | 4.5 | | | 86 | 14 | 2 |
| E29 | 50 | 15.3 | — | 30.2 | — | 4.5 | — | — | 77 | 10 | 4 |
| E30 | 75.5 | 20 | — | — | — | 4.5 | — | — | 85.5 | 61 | 3 |
| E31 | 60 | — | 35.5 | — | — | 4.5 | — | — | 87 | 19 | 1 |
| E32 | 75 | 25 | — | — | — | — | — | — | 88 | 76 | 5 |
| E33 | 35 | 19 | 40 | — | — | 6 | — | — | 82 | 4 | 1 |

The results in TABLE 3 illustrate the advantageous effect that a polyester-based urethane has on water fastness as compared to a polyether-based urethane. Thus, E20 and E21 are compositionally identical except that E20 contains a urethane having a polyester backbone while E21 contains a polyurethane having a polyether backbone. However, E20 has excellent water resistance, while E21 has poor water resistance. A similar effect is seen with E28 and E29. Indeed, the water resistance of E20 was so good that the imaged substrate could be submerged in water for weeks without any noticeable bleeding of the dyes. E20 also illustrates that, in some cases, the use of a urethane having a polyester backbone provides for good water fastness even in the absence of an alkoxy silane or an amino acrylate polymer (at least in the presence of a tris-aziridine crosslinking agent).

The results of TABLE 3 further indicate the beneficial effect that the urethane has on curl. Thus, the worst curl values were observed with E30 and E32, both of which are devoid of polyurethane.

The results in TABLE 3 also illustrate the advantageous effect that a polyester-based urethane has on gloss as compared to a polyether-based urethane. Thus, E20 and E21 are compositionally identical except that E20 contains a urethane having a polyester backbone while E21 contains a polyurethane having a polyether backbone. However, E20 has somewhat better gloss than E21. A similar effect is seen with E28 and E29.

### EXAMPLES E34-E38

These examples illustrate the affect on water rub properties of various swellable polymers in the ink receptive coating compositions described herein.

Following the general methodology of EXAMPLES E1-E10, several ink receptive substrates were prepared based on the coating compositions denoted E34-E38 in TABLE 4. These coating compositions were prepared by mixing together in water the following materials in the indicated percentages by weight: 35% W213, 7% Poly DMAEMA, 10% SYN, 1% U-NFW (an optical brightening agent), and 47% of the water-swellable polymer indicated in TABLE 4. The treated substrates were then subjected to the Water Rub Test, the results of which are also set forth in TABLE 4.

TABLE 4
Water Rub Test Results for Coatings Based on Various
Water-Swellable Polymers

| EXAMPLE | Swellable Polymer Type | Water Rub Test |
|---|---|---|
| E34 | K-35 | 2 |
| E35 | A4M | 1 |
| E36 | N-250L | 1 |
| E37 | PVP | 3 |
| E38 | A-500 | 5 |

The results of TABLE 4 illustrate the surprisingly good water rub resistance afforded by the use of cellulosic materials as the swellable polymer in the ink receptive coating compositions described herein as compared to similar coatings based on other commonly used swellable polymers. In particular, the coatings based on hydroxy propyl methylcellulose (E34), methyl cellulose (E35), and hydroxy ethyl cellulose (E36) all exhibited good or excellent water rub resistance. By contrast, the corresponding coating formulations based on PVP (E37) and polyethyl oxazoline (E38) showed notably worse water rub resistance, with the later being especially bad.

### EXAMPLES E39-E48

These examples illustrate the effect that the weight % of alkoxy silane has on the water resistance of a coating.

Following the general methodology of EXAMPLES E1-E10, several ink receptive substrates were prepared based on the coating compositions denoted E39-E46 in TABLE 5. In each case, the dried coating thickness was about 1.4 g/ft² (15 g/m²). The resulting substrates were then subjected to the Water Rub Test, the results of which are also set forth in TABLE 5.

TABLE 5
Water Rub Test Results for Various Levels of cellulose/alkoxy silane

| | K-35 | A1120 | | |
|---|---|---|---|---|
| EXAMPLE | (%) | (%) | UCX | Water Rub Test |
| E39 | 95 | 5 | — | 4 |
| E40 | 90 | 10 | — | 4 |
| E41 | 85 | 15 | — | 3 |
| E42 | 80 | 20 | — | 2 |
| E43 | 75 | 25 | — | 2 |
| E44 | 70 | 30 | — | 1 |
| E45 | 60 | 40 | — | 1 |
| E46 | 50 | 50 | — | 1 |
| E31 | 60 | 4.5 | 35.5 | 1 |

As the results of TABLE 5 indicate, a level of alkoxy silane of at least about 20% was required to achieve a coating that did not rub off easily, and a level of alkoxy silane of at least about 30% was required to achieve a coating that did not rub off at all. At these levels, the alkoxy silane has a deleterious effect on image quality (e.g., the image quality is noticeably poor at an alkoxy silane level of 30%), due in part to an accompanying reduction in the absorbency of the coating composition toward aqueous ink compositions of the type commonly used in inkjet printers. Indeed, image quality becomes progressively worse with increasing levels of alkoxy silane when the amount of alkoxy silane exceeds about 10%.

By contrast, E31 exhibited excellent water rub properties at much lower levels of alkoxy silane. Also, as seen from TABLE 3, E31 exhibited excellent water fastness (rated a 1 in the Water Fastness Test). Hence, these examples illustrate that the inclusion in the ink receptive coating compositions described herein of a cationic urethane dispersion dramatically and surprisingly reduces the level of alkoxy silane required for good water resistance properties (for both the coating as a whole and for the ink absorbed into the coating). Moreover, the reduction in the level of alkoxy silane allows the coating to have good absorbency toward aqueous ink compositions of the type commonly used in inkjet printers. Consequently, the detrimental effect that alkoxy silanes can have on the absorption of water-based inks can be minimized, and ink receptive coatings can be made based on these materials which have both excellent water resistance and excellent ink absorption.

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

What is claimed is:

1. An ink receptive coating composition, comprising:
a cellulosic polymer;
a cationic polyurethane dispersion; and
a material selected from the group consisting of alkoxysilanes and cationic amino acrylate polymers.

2. The composition of claim 1, wherein said cellulosic polymer is water-soluble and wherein said cationic polyurethane is water-dispersible.

3. The composition of claim 1, wherein said cellulosic polymer is an alkyl cellulose.

4. The composition of claim 1, wherein said cellulosic polymer is hydroxypropyl methyl cellulose.

5. The composition of claim 1, wherein the cationic urethane has a polyether linkage.

6. The composition of claim 1, wherein the cationic urethane has a polyester linkage.

7. The composition of claim 6, wherein the cationic polyurethane has a polyester backbone.

8. The composition of claim 1, wherein the material is a cationic amino acrylate polymer having a molecular weight of at least about 100,000 g/mol.

9. The composition of claim 8, wherein the composition comprises an amino acrylate polymer having a molecular weight of at least about 1×10⁶ g/mol.

10. The composition of claim 8, wherein said cationic amino acrylate polymer has a molecular weight of at least about 2×10⁶ g/mol.

11. The composition of claim 8, wherein said cationic amino acrylate polymer is a polydimethylaminoethyl methacrylate salt.

12. The composition of claim 8, wherein said cationic amino acrylate polymer is a polydimethylaminoethyl methacrylate acetate salt.

13. The composition of claim 1, further comprising an alkoxy silane.

14. The composition of claim 1, further comprising an aminoalkoxy silane.

15. The composition of claim 14, wherein the aminoalkoxy silane is N-beta aminoethyl gamma-aminopropyltrimethoxy silane.

16. The composition of claim 1, further comprising a cationic mordant.

17. The composition of claim 1, further comprising a crosslinking agent.

18. The composition of claim 1, wherein said alkylcellulose polymer is present in the composition as a continuous phase, and wherein the cationic urethane is present in the composition as a disperse phase.

19. A composition, comprising:
a water soluble cellulose polymer;
a cationic polyurethane dispersion; and
a cationic amino acrylate polymer having a molecular weight of at least about 100,000 g/mol.

20. The composition of claim 19, wherein said cationic amino acrylate polymer has a molecular weight of at least about 1×10⁶ g/mol.

21. The composition of claim 19, wherein said cationic amino acrylate polymer has a molecular weight of at least about 2×10⁶ g/mol.

22. The composition of claim 19, wherein said cationic amino acrylate polymer is a polydimethylaminoethyl methacrylate.

23. The composition of claim 19, wherein said cationic amino acrylate polymer is a polydimethylaminoethyl methacrylate acetate salt.

24. An inkjet printable article, comprising:
a substrate; and
an image receptor layer disposed on said substrate, said receptor layer comprising (a) a water-soluble alkyl cellulose polymer, (b) a water dispersible cationic urethane polymer, and (c) a material selected from the group consisting of alkoxysilanes and polydimethylaminoethyl methacrylate salts.

25. The inkjet printable article of claim 24, wherein said substrate is a cellulosic substrate.

26. The inkjet printable article of claim 24, wherein said alkylcellulose polymer is present in the composition as a continuous phase, and wherein the cationic urethane is present in the composition as a disperse phase.

27. The inkjet printable article of claim 24, wherein the cationic polyurethane is a cationic amino acrylate polymer having a molecular weight of at least about 100,000 g/mol.

28. The inkjet printable article of claim 24, wherein the composition comprises an amino acrylate polymer having a molecular weight of at least about 1×10⁶ g/mol.

29. The inkjet printable article of claim 24, wherein said cationic amino acrylate polymer has a molecular weight of at least about 2×10⁶ g/mol.

30. A method for creating an inkjet receptive surface, comprising the steps of:
providing a substrate; and
coating the substrate with a composition comprising (a) a water-soluble alkyl cellulose polymer, (b) a water dispersible cationic urethane, and (c) a material selected from the group consisting of alkoxysilanes and polydimethylaminoethyl methacrylate salts.

31. The method of claim 30, wherein the alkyl cellulose polymer is water soluble in the absence of component (c).

32. The method of claim 30, wherein the urethane is a polymer.

33. The method of claim 30, wherein the urethane is water dispersible.

34. A method for creating an inkjet receptor coating, comprising the steps of:
providing a water-soluble blend comprising a water-soluble alkyl cellulose polymer and a cationic urethane polymer; and
treating the blend with a material selected from the group consisting of alkoxysilanes and polydimethylaminoethyl methacrylate salts, thereby producing a treated blend which is insoluble in water.

35. The method of claim 34, further comprising the step of applying the treated blend to a substrate.

36. A coating composition suitable for use in inkjet printing substrates, comprising:
a water-soluble alkyl cellulose polymer;
a water dispersible cationic urethane polymer; and
an insolubilizing agent adapted to render the alkyl cellulose polymer insoluble in water, said agent being selected from the group consisting of alkoxysilanes and polydimethylaminoethyl methacrylate salts.

37. The coating composition of claim 36, wherein the insolubilizing agent is further adapted to render the alkyl cellulose polymer insoluble in water.

38. A coating composition suitable for use in inkjet printing substrates, comprising:
an alkyl cellulose polymer; and
a cationic polyurethane polymer having a polyester backbone.

39. The coating composition of claim 38, further comprising a mordant.
